(19) United States
(12) Patent Application Publication
(10) Pub. No.: US 2007/0240201 A1
(43) Pub. Date: Oct. 11, 2007

(54) User end management system and method

(75) Inventors: Shan-Fa Shih, Taipei (TW); Johnny Cui, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/394,670

(22) Filed: Mar. 31, 2006

(51) Int. Cl. H04L 9/32

(52) U.S. Cl. 726/4

(57) ABSTRACT

A user-end management system and method applicable to a factory information system is proposed. A physical address of the user-end computer and its corresponding IP address and computer name are collected and stored in a database. Then, it determines whether a physical address of a user-end computer is stored in the database when the user-end computer logs in the factory information system. If no, the logged user-end computer is locked from further proceeding. If yes, it further examines whether an IP address and a computer name of the logged user-end computer are identical to those stored in the database corresponding to the physical address thereof, wherein the IP address and the computer name of the logged user-end computer are changed to be those stored in the database corresponding to the physical address thereof, and the user-end computer is restarted.

### BACKGROUND OF THE INVENTION

1. Field of the Invention

The present invention relates to a new technology application in network resource management, and more particularly, to a user-end management system and method.

2. Description of Related Art

The conventional Factory Information System (FIS) is constructed on an independent web domain and generally, the FIS web domain comprises three primary servers including DC (Domain Control), SQL and IIS (Internet Information Services). The DC server is adapted to mainly assign IP addresses (Dynamic Host Configuration Protocol, DHCP), analyze domain names and function variables (Domain Name System, DNS), and support web domain policies (Group Policy). The IIS server is used to provide access (Access) to the FIS system network, whereas the SQL is used to provide database services to the FIS system and Manufacturing Execution System, MES. In a manufacturing factory system, the aforementioned servers are usually connected to a core exchange board, and every production line of a manufacturing factory is equipped with a specific exchange board for connecting the core exchange board, moreover, all user-end computers are provided to connect to the exchange board of the production line.

The entire FIS user-end computer is constructed on a specific web domain, a user-end computer uses an operating system, such as Win 2000, to login to an account, then the user-end computer, according to the Group Policy Operation, GPO, establishes a policy for the user-end computer, such that partial functions of a user-end computer can be restricted and a series of trust website or security options for the user-end computer can be configured for allowing a user-end computer to login to the FIS system for productive operation.

A number of drawbacks has been known to exist in the foregoing FIS system including:
1. A DC server crash: The DHCP and DNS are controlled by DC, in the case of a DC crash, computers in a production line will not be able to obtain IP even though an IP substitute is available but cannot communicate with the server normally, thereby adversely causing the production line unable to function and resulting in cease-production.
2. Cut-off power supply of a production line exchange board: which is usually caused by a user-end suddenly that leads to the entire cease-production.
3. Cut-off power supply of a core exchange board, which is usually caused by touching the power supply or a sudden cause that leads to all-round cease-production.
4. User-end without joining the trust web domain, which usually caused by failures in logging and a repeated name in the web domain caused by a user-end, causing a single station point not able to function normally.
5. Conflicts of IP addresses: Only a server could have a fixed IP in a conventional FIS system, which is caused by an IP in a user-set server when connecting to the FIS system, and it often occurs in places of semi-fabrication and maintenance where the FIS has least and weak control and which may cause malfunction on one of the servers and even a full-round cease-production as a result.
6. Conflicts of the computer name: A user-end computer of a prior FIS system is provided with a specific computer name, which may repeat itself if a user duplicates the hardware driver himself and that may lead to failures of imitating the policy in an AD web domain and cause two station points unable to be used one after another. Further, a web page error message may appear and be displayed on the user end.
7. Occupancy of IP address: The IP of a user end in a prior FIS system is delivered by the DHCP service of DC, if a user incautiously connects the server for Image Download or AP for detecting the wireless network accessing point to the FIS network, all computers of the entire production line will not be able to acquire the IP, which may cause cease production of the semi-fabricated and finished station points.
8. Problems of SQL server: The SQL server is the core of the entire FIS and any error thereof may seriously affect the stability of the upper FIS system architecture. Higher ratio of problems tends to occur under high workload, such as inadequate disc space of the SQL server, over low SQL index scan density or failures of SQL substituted service. Therefore, how to provide an improved method that can overcome the defects of a known FIS system, is a critical need in the art.

### SUMMARY OF THE INVENTION

In view of the above-mentioned problems of the prior art, a primary objective of the present invention is to provide a user-end management system and method that obviates the use of web domains and DHCP and has a fixed IP for proceeding functions and services, thereby reducing clash, collision and impact of DNS and DHCP that may have on the system, such that incidents of full-round cease-production in a production line can be effectively prevented.

Another objective of the present invention to provide a user-end management system and method having the server end thereof equipped with an on-line user-end list to allow its server end to be able to inform the responsible staff of a production line of machinery breakdowns or in the event of a machinery completely out of a production line.

Still another objective of the present invention is to provide a user-end management system and method that can directly control the addition of trust web sites and can be managed and restrained by the server.

Still another objective of the present invention is to provide a user-end management system and method that uses the Shell substitute operating system, does not provide any system services to the users of a production line but only the basic function of a browser, and does not provide an authorization function for the users to change IP.

Still another objective of the present invention is to provide a user-end management system and method that can directly change its computer name and be managed by the server.

Still another objective of the present invention is to provide a user-end management system and method that can prevent any IP therein from being acquired by canceling DHCP service to assign IP, even if an image download and AP is connected to FIS web points.

Still another objective of the present invention is to provide a user-end management system and method that can transmit information in real-time and communicate with the user-end directly, thereby shortening the time required for responding to an incident handling concrete

To achieve the above-mentioned and other objectives, the present invention proposes a user-end management system, which is applicable to a factory information system connected via a network system to a server end and a user-end computer. The user-end management system includes: a collecting module for collecting a physical address of the user-end computer and its corresponding IP address and computer name; a database for storing the physical address of the user-end computer and its corresponding IP address and computer name, which are collected by the collecting module; and a control module for determining whether a physical address of a user-end computer is stored in the database when the user-end computer logs in the factory information system; if no, locking the logged user-end computer to stop it from proceeding; or if yes, further examining if an IP address and a computer name of the logged user-end computer are identical to those stored in the database corresponding to the physical address thereof, wherein if the IP address and the computer name of the logged user-end computer are not identical to those stored in the database corresponding to the physical address, the IP address and the computer name of the logged user-end computer are changed to be those stored in the database corresponding to the physical address thereof and the user-end computer is restarted.

In one form of the present invention, the user-end management system further includes a transmission module for transmitting management information of the user-end to the user-end computer and receiving notices of breakdown transmitted from the user-end.

By the user-end management system, the present invention also proposes a user-end management method, which is applicable to a factory information system connected via a network system to a server end and a user-end computer. The user-end management method comprises the steps of: (1) collecting a physical address of the user-end computer and its corresponding IP address and computer name; (2) storing the physical address of the user-end computer and its corresponding IP address and computer name in a database; (3) determining whether a physical address of a user-end computer is stored in the database when the user-end computer logs in the factory information system; if no, proceeding to step (4), or if yes, proceeding to step (5); (4) locking the logged user-end computer to stop it from proceeding; (5) examining whether an IP address and a computer name of the logged user-end computer are identical to those stored in the database corresponding to the physical address thereof; if no, proceeding to step (6), or if yes, ending the method; and (6) changing the IP address and the computer name of the logged user-end computer to those stored in the database corresponding to the physical address thereof.

Compared to the prior techniques, the user-end management system and method disclosed by the present invention can realize and achieve the foregoing objectives of the invention by employing useful mechanisms of a collecting module, a database, a transmission module and a control module, thereby canceling web domains and DHCP, using fixed IP to proceed services and functions, and reducing clash and impact of DNS and DHCP on the system.

### BRIEF DESCRIPTION OF DRAWINGS

The invention can be more fully understood by reading the following detailed description of the preferred embodiments, with reference made to the accompanying drawings, wherein:

FIG. 1 is a schematic view showing the application architecture of the user-end management system according to the present invention; and

FIG. 2 is a flow chart showing the steps of executing the user-end management method according to the present invention.

### DETAILED DESCRIPTION OF PREFERRED EMBODIMENTS

The following illustrative embodiments are provided to illustrate the disclosure of the present invention, these and other advantages and effects being readily understood by those in the art after reading the disclosure of this specification. The present invention can also be performed or applied by other differing embodiments. The details of the specification may be modified on the basis of different points and applications, and numerous modifications and variations can be devised without departing from the spirit of the present invention.

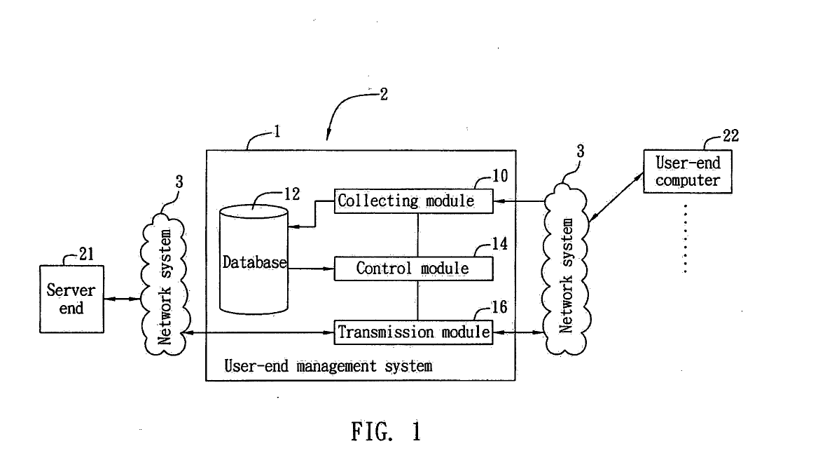

Referring to FIG. 1, the application architecture of the user-end management system according to the present invention is illustrated. As shown, the user-end management system 1 is applied to a factory information system 2 and is interconnected with a server end 20 in the factory information system 2 and a user-end computer 22 via a network system 3. The user-end management system 1 includes: a collecting module 10, a database 12, a control module 14, and a transmission module 16.

The collecting module 10 is used to collect data of the physical address of a user-end computer with its respective IP address and computer name. In this embodiment, a new SHELL interface is constructed on the collecting module 10 via the user-end computer 22, and the collecting module 10 collects the physical address of the user-end computer 22 with its respective IP and computer name after entering into the new SHELL interface. In this embodiment, the establishment of the new interface can be realized by way of, for example, amending windows registration (regedit), more specifically, adding an item “HKEY_CURRENT_USER\Software\Microsoft\Windows\CurrentVersion\Policies\system”, and then key in a value, such as “c:fissys\ic.exestring”, making the IP of the user-end computer an absolute location. The collecting module 10 collects the physical address with its respective IP and computer name of the user-end computer and then transmits the same to the database 12 of the server end 20.

The database 12 is used to store data of the physical address of the user-end computer with its respective IP address and computer name that are collected by the collecting module 10, and serves as preset computer names corresponding to the IP of the user-end computer 22.

The control module 14 is used to determine whether the physical address of the user-end computer 22 is stored in the database 12 when the user-end computer 22 logs in the factory information system 2; if not stored therein, proceed to lock the user-end computer and whereas if the address is found therein, further examine whether the IP address of the user-end computer 22 and its respective computer name are stored in the database 12; if not, proceed to change directly the IP address and computer name to be the same as previously stored in the database and restart the user-end computer 22.

The transmission module 16 is used to transmit information on the user-end management to the user-end computer 22 and to receive notices of breakdown sent from the user-end computer 22. In this embodiment, when the user-end computer 22 is locked by the control module 14 to discontinue the process, the server end 20 can transmit information of handling by means of the transmission module 16 via the network system 3 to the user-end computer 22. Similarly, the user-end computer can transmit information on questions of the control behavior or notices of breakdown by means of the transmission module 16 via the network system 3 to the server end 20, thereby allowing an administrator to control the user-end computer accordingly. The transmission module 16 is the specification of the Socket communication.

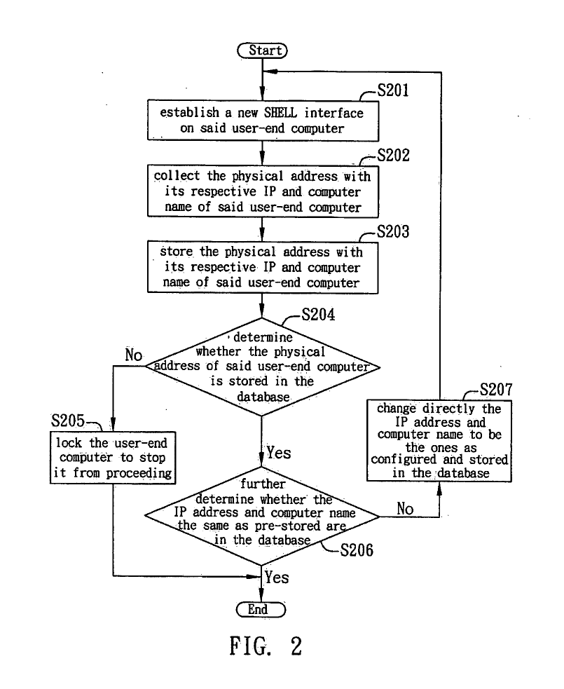

FIG. 2 is a flow chart illustrating the steps of executing the user-end management method by applying the user-end management system.

In step S201, establish a new SHELL interface on the user-end computer 22. Then, flow proceeds to step S202.

In step S202, collect the physical address with its respective IP and computer name of the user-end computer 22. Flow proceeds to step S203.

In step S203, store the physical address and its respective IP and computer name of the user-end computer 22. Flow proceeds to step S204.

In step S204, determine whether the physical address of the user-end computer 22 is stored in the database 12; if not, flow proceeds to step S205; whereas if yes, flow proceeds to step S206.

In step S205, lock the user-end computer 22 to stop it from proceeding.

In step S206, further determine whether the IP address and computer name are the same as pre-stored in the database 12; if not, flow proceeds to step S207, whereas if yes, ends the process.

In step S207, change directly the IP address and computer name to be the ones as configured and stored in the database 12, and then returns to step S201.

Compared to the prior techniques, the user-end management system and method of the present invention employ mechanisms of a collecting module, a database, a transmission module and a control module to realize and achieve the foregoing objectives, thereby canceling web domains and DHCP, using fixed IP to proceed services and functions, and reducing clash and impact of DNS and DHCP on the system.

The foregoing descriptions of the detailed embodiments are illustrated to disclose the features and functions of the present invention and are not restrictive of the scope of the present invention. It should be understood by those in the art that various modifications and variations can be made to the present invention according to the spirit and principle in the disclosure and yet fall within the scope of the appended claims.

What is claimed is:

1. A user-end management system, which is applicable to a factory information system connected via a network system to a server end and a user-end computer, the user-end management system comprising,
a collecting module for collecting a physical address of the user-end computer and corresponding IP address and computer name thereof;
a database for storing the physical address of the user-end computer and the corresponding IP address and computer name thereof collected by the collecting module; and
a control module for determining whether a physical address of a user-end computer is stored in the database when the user-end computer logs in the factory information system; if no, locking the logged user-end computer to stop it from proceeding; or if yes, further examining if an IP address and a computer name of the logged user-end computer are identical to those stored in the database corresponding to the physical address thereof, wherein if the IP address and the computer name of the logged user-end computer are not identical to those stored in the database corresponding to the physical address, the IP address and the computer name of the logged user-end computer are changed to be those stored in the database corresponding to the physical address thereof and the user-end computer is restarted.

2. The user-end management system of claim 1, wherein the collecting module establishes a new SHELL interface via the user-end computer, and after entry into the new SHELL interface, the collecting module collects the physical address of the user-end computer and its corresponding IP and computer name.

3. The user-end management system of claim 1, further comprising a transmission module for transmitting information on user-end management to the user-end computer and receiving a notice of breakdown sent from the user-end computer.

4. A user-end management method, which is applicable to a factory information system connected via a network system to a server end and a user-end computer, the user-end management method comprising the steps of:
(1) collecting a physical address of the user-end computer and corresponding IP address and computer name thereof;
(2) storing in a database the physical address of the user-end computer and the corresponding IP address and computer name thereof;
(3) determining whether a physical address of a user-end computer is stored in the database when the user-end computer logs in the factory information system;
if no, proceeding to step (4), or if yes, proceeding to step (5);
(4) locking the logged user-end computer to stop it from proceeding;
(5) examining whether an IP address and a computer name of the logged user-end computer are identical to those stored in the database corresponding to the physical address thereof; if no, proceeding to step (6), or if yes, ending the method; and
(6) changing the IP address and the computer name of the logged user-end computer to those stored in the database corresponding to the physical address thereof.

5. The user-end management method of claim 4, further comprising a step of establishing a new SHELL interface on the user-end computer and entering the new SHELL interface prior to executing step (1).
